(19) United States
(12) Patent Application Publication
(10) Pub. No.: US 2014/0307468 A1
(43) Pub. Date: Oct. 16, 2014

(54) LIGHT GUIDE PLATE AND BACKLIGHT MODULE

(71) Applicant: HON HAI PRECISION INDUSTRY CO., LTD, New Taipei (TW)

(72) Inventor: YUNG-CHANG TSENG, New Taipei (TW)

(21) Appl. No.: 13/945,913

(22) Filed: Jul. 19, 2013

(30) Foreign Application Priority Data
Apr. 12, 2013 (TW) 102112949

(51) Int. Cl. F21V 8/00

(52) U.S. Cl. CPC G02B 6/0016
USPC 362/608

(57) ABSTRACT

A light guide plate includes a light emitting surface, a bottom surface opposite to the light emitting surface, a first side surface, a second side surface, and a light incident surface. The first side surface and the second side surface connect the light emitting surface to the bottom surface. The light incident surface is connected to the light emitting surface, the bottom surface, the first side surface, and the second side surface. A plurality of diffusing micro-structures is formed on the light incident surface.

### BACKGROUND

1. Technical Field

The present disclosure relates to a light guide plate and a backlight module including the light guide plate.

2. Description of Related Art

A hand-held device usually has a small display. For illuminating the small display, only one light source is needed. FIG. 1 shows that a backlight module of the hand-held device includes a light guide plate 11 and a light source 10. The light source 10 is a light emitting diode (LED). The light guide plate 11 includes side surfaces 15, 17 perpendicular to each other. The light source 10 is positioned adjacent to a corner of the light guide plate 11. Yet, as light emitting from the light source 10 is refracted and changes the transmission direction when entering the light guide plate 11, the light cannot illuminate part of the light guide plate 11 adjacent to the side surfaces 15, 17 (i.e., areas between the side surfaces 15, 17 and dashed lines in FIG. 1) and make the part useless. Thus, the utilization coefficient of the light guide plate 20 is low.

Therefore, it is desirable to provide a light guide plate and a backlight module having the light guide plate which can overcome the limitations described.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a backlight module of related art.

FIG. 2 is a schematic view of a backlight module according to an exemplary embodiment of the present disclosure, the backlight module including a light guide plate.

FIG. 3 is a schematic, isometric view of the light guide plate of FIG. 2.

FIG. 4 is an enlarged view of a circled part IV of FIG. 2.

FIGS. 5-7 show distribution of light intensity on a light emitting surface of the light guide plate of FIG. 3 under different conditions.

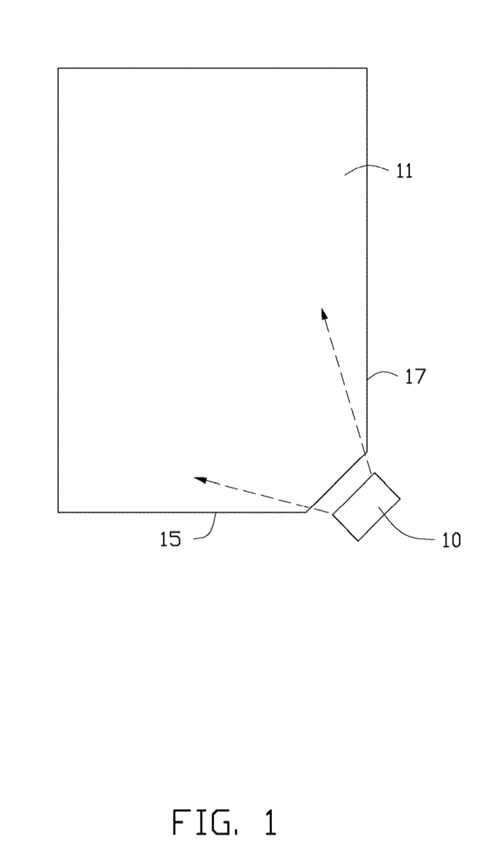

### DETAILED DESCRIPTION

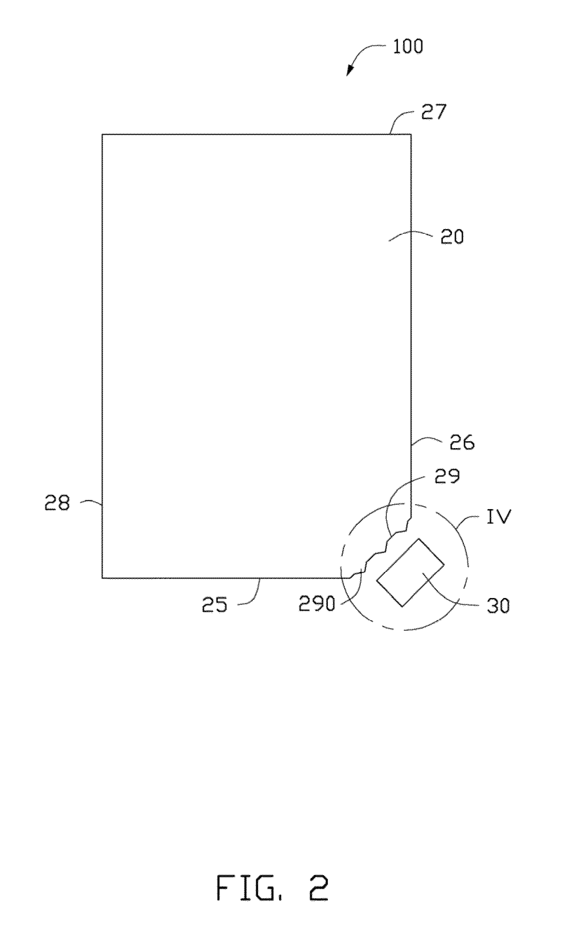

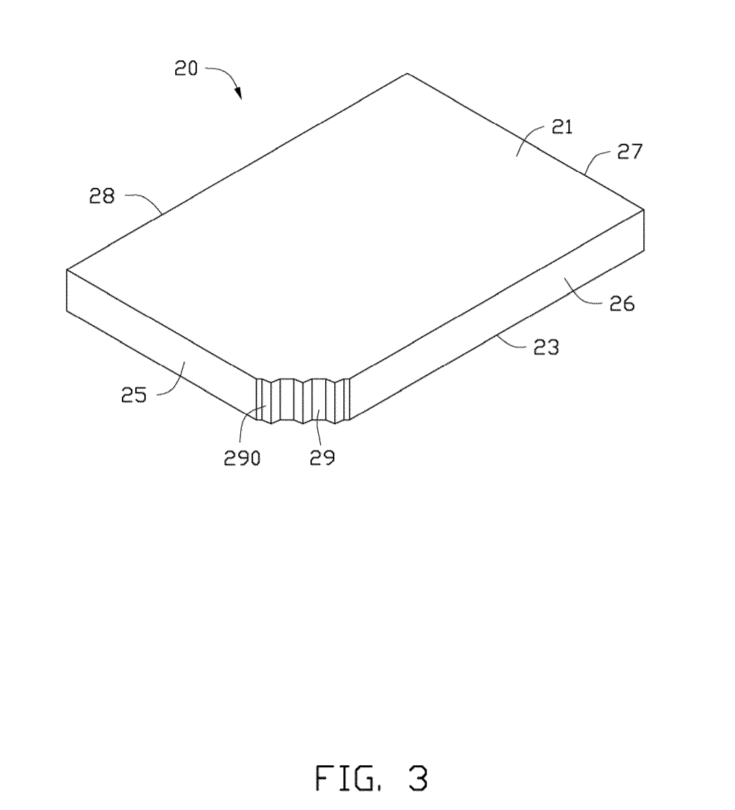

FIGS. 2 and 3 show a backlight module 100 according to an exemplary embodiment of the present disclosure. The backlight module 100 includes a light guide plate 20 and a light source 30. In this embodiment, the light source 30 is a light emitting diode (LED). A divergence angle of light emitting from the light source 30 is ±90 degrees.

The light guide plate 20 is made of transparent resin, such as polymethyl methacrylate (PMMA). A refraction index of the light guide plate 20 is about 1.5. The light guide plate 20 includes a light emitting surface 21, a bottom surface 23 opposite to the light emitting surface 21, a first side surface 25, a second side surface 26, a third side surface 27, and a fourth side surface 28. The first side surface 25, the second side surface 26, the third side surface 27 and the fourth side surface 28 connect the light emitting surface 21 to the bottom surface 23. The first side surface 25 is perpendicular to the second side surface 26. The first side surface 25 is opposite to the third side surface 27. The second side surface 26 is opposite to the fourth side surface 28.

The light guide plate 20 further includes a light incident surface 29. The light incident surface 29 is connected to the light emitting surface 21, the bottom surface 23, the first side surface 25, and the second side surface 26. The light source 30 faces the light incident surface 29.

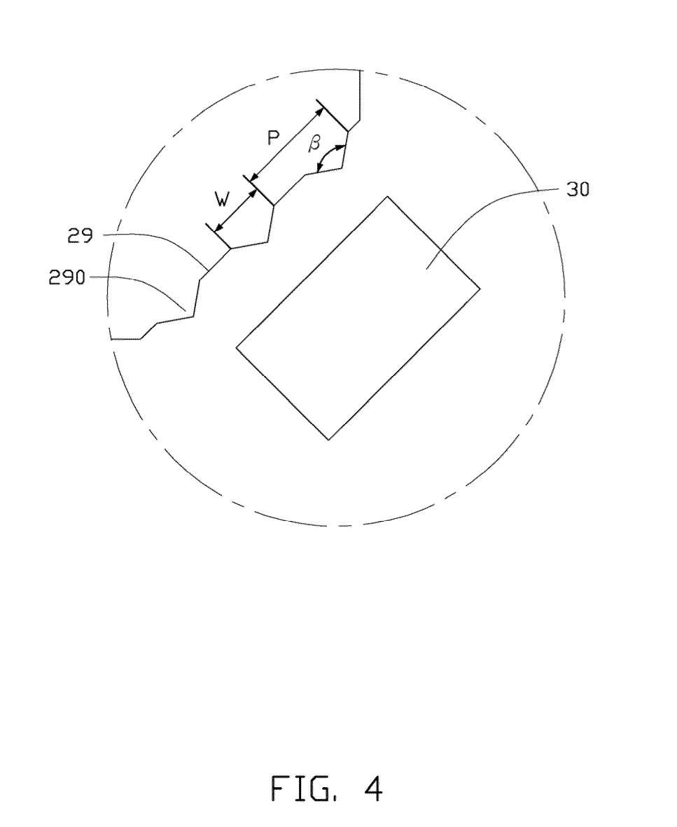

FIG. 4 shows that a number of diffusing micro-structures 290 are formed on the light incident surface 29. The diffusing micro-structures 290 are used to diffuse light emitting from the light source 10 and make the light illuminate the whole light guide plate 20. In this embodiment, the diffusing micro-structures 290 are V-shaped strips projecting on the light incident surface 29. The V-shaped strips 290 extend along a direction perpendicular to the light emitting surface 21. Sectional surfaces of the V-shaped strips 290 parallel to the light emitting surface 21 are isosceles triangles. The V-shaped strips 290 are spaced from each other and are periodically arranged on the light incident surface 29.

Each of the isosceles triangles defines a top angle β and a width W. The V-shaped strips 290 have a period P. The width W is length of a side of the isosceles triangle opposite to the top angle β. The period P is sum of the width W and a distance between each two neighboring V-shaped strips 290. Values of the top angle β, the width W and the period P affect distribution of light intensity on the light emitting surface 21. When values of the top angle β, the width W and the period P are improper, the distribution of the light intensity on the light emitting surface 21 maybe uneven.

Upon numerous experiments, it is obtained that when the top angle β is equal to 110 degrees, the distribution of the light intensity on the light emitting surface 21 is even.

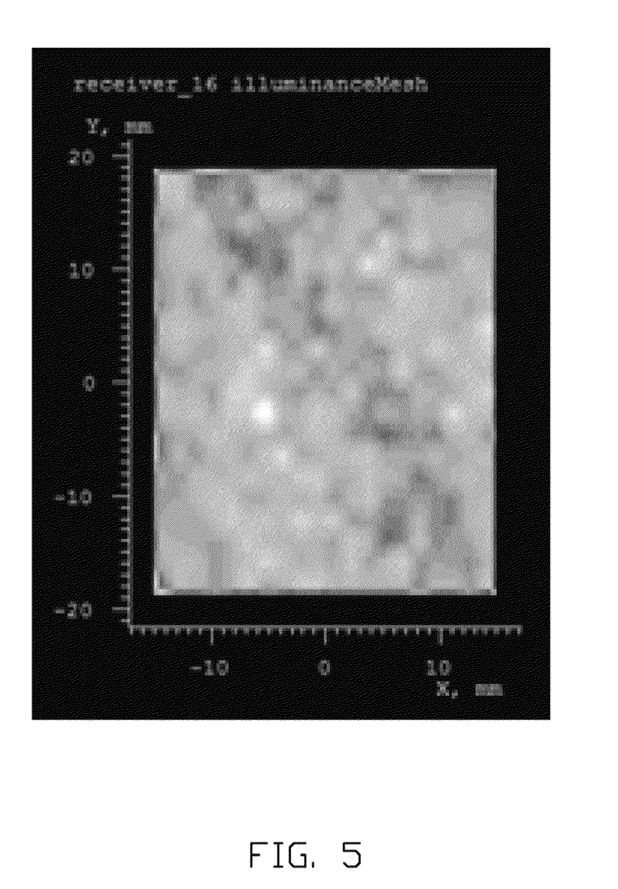

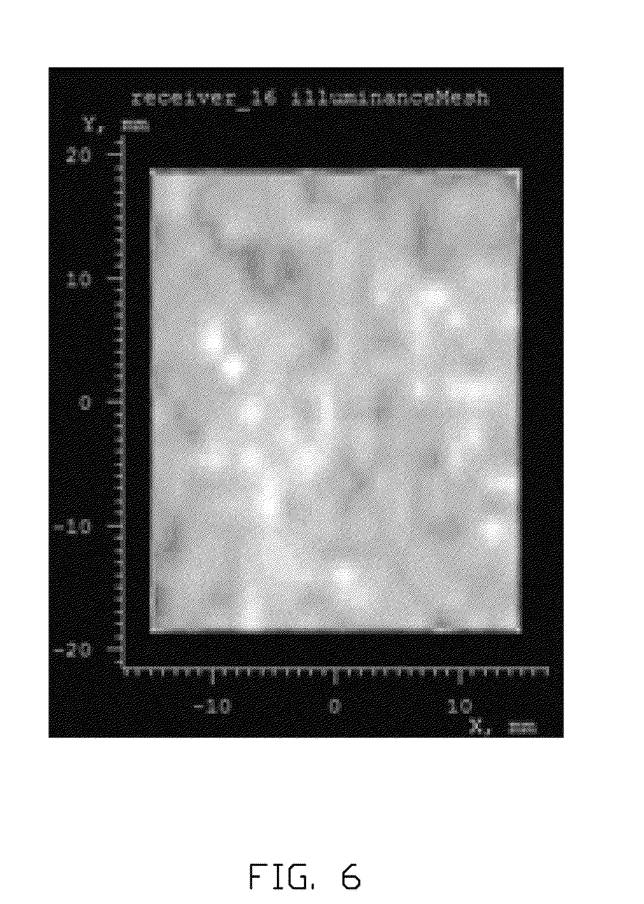

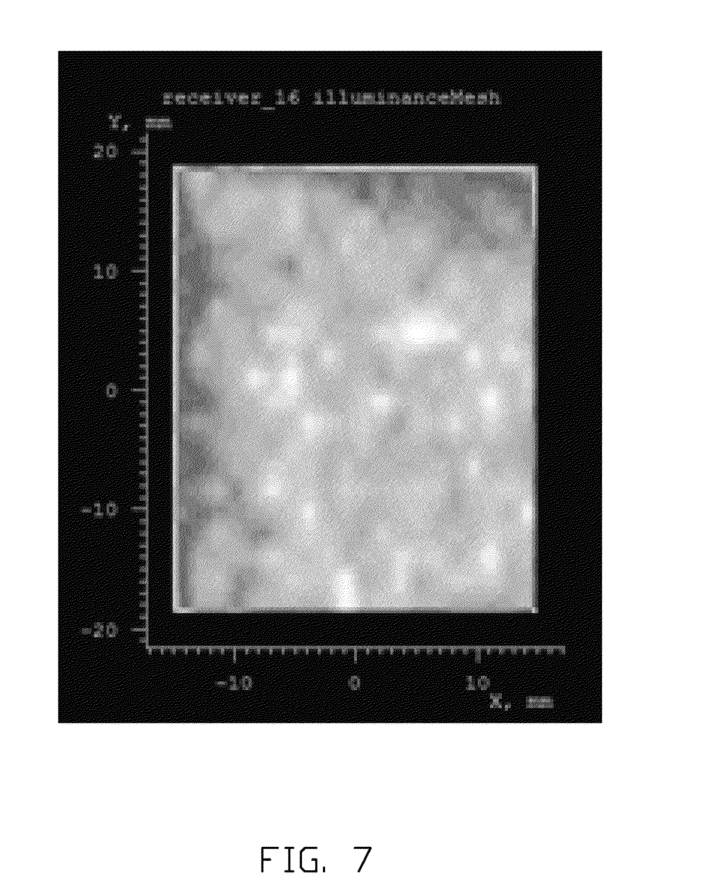

FIG. 5 shows that when the width W is equal to 120 micrometers (um), the period P is equal to 190 um, and a ratio of the period P to the width W is equal to 19/12, the distribution of the light intensity on the light emitting surface 21 is even. FIG. 6 shows that when the width W is equal to 120 micrometers (um), the period P is equal to 200 um, and a ratio of the period P to the width W is equal to 5/3, the distribution of the light intensity on the light emitting surface 21 is even. FIG. 7 shows that when the width W is equal to 120 micrometers (um), the period P is equal to 240 um, and a ratio of the period P to the width W is equal to 2, the distribution of the light intensity on the light emitting surface 21 is even.

The light incident surface 29 forms a number of diffusing microstructures 290. Thus, light emitting from the light source 30 can illuminate the whole light guide plate 20 and the utilization coefficient of the light guide plate 20 is enhanced.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A light guide plate comprising:
a light emitting surface;
a bottom surface opposite to the light emitting surface;
a first side surface and a second side surface both connecting the light emitting surface to the bottom surface;
a light incident surface connected to the light emitting surface, the bottom surface, the first side surface, and the second side surface; and
a plurality of diffusing micro-structures on the light incident surface.

2. The light guide plate of claim 1, wherein the first side surface is perpendicular to the second side surface.

3. The light guide plate of claim 1, wherein the diffusing micro-structures are V-shaped strips projecting on the light incident surface.

4. The light guide plate of claim 3, wherein the V-shaped strips extend along a direction perpendicular to the light emitting surface, a sectional surface of each of the V-shaped strips in a direction parallel to the light emitting surface is an isosceles triangle.

5. The light guide plate of claim 4, wherein the isosceles triangle comprises a top angle, and the top angle is equal to 110 degrees.

6. The light guide plate of claim 4, wherein the V-shaped strips are periodically formed on the light incident surface and have a period, the isosceles triangle has a width, a ratio of the period to the with is in a range from 19/12 to 2.

7. The light guide plate of claim 6, wherein the period is in a range from 190 micrometers to 240 micrometers, and the width of the isosceles triangle is equal to 120 micrometers.

8. A backlight module comprising:
a light guide plate comprising:
a light emitting surface;
a bottom surface opposite to the light emitting surface;
a first side surface and a second side surface connecting the light emitting surface to the bottom surface;
a light incident surface connected to the light emitting surface, the bottom surface, the first side surface, and the second side surface; and
a plurality of diffusing micro-structures on the light incident surface; and
a light source facing the light incident surface.

9. The backlight module of claim 8, wherein the first side surface is perpendicular to the second side surface.

10. The backlight module of claim 8, wherein the diffusing micro-structures are V-shaped strips projecting on the light incident surface.

11. The backlight module of claim 10, wherein the V-shaped strips extend along a direction perpendicular to the light emitting surface, a sectional surface of each of the V-shaped strips in a direction parallel to the light emitting surface is an isosceles triangle.

12. The backlight module of claim 11, wherein the isosceles triangle comprises a top angle, and the top angle is equal to 110 degrees.

13. The backlight module of claim 11, wherein the V-shaped strips are periodically formed on the light incident surface and have a period, the isosceles triangle has a width, and a ratio of the period to the with is in a range from 19/12 to 2.

14. The backlight module of claim 13, wherein the period is in a range from 190 micrometers to 240 micrometers, and the width of the isosceles triangle is equal to 120 micrometers.

15. The backlight module of claim 8, wherein the light source is a light emitting diode.
